(19) United States
(12) Patent Application Publication
(10) Pub. No.: US 2018/0365735 A1
(43) Pub. Date: Dec. 20, 2018

(54) DISPLAYING AN ADVERTISEMENT FOR A PRODUCT OF INTEREST

(71) Applicant: International Business Machines Corporation, Armonk, NY (US)

(72) Inventors: Eli M. Dow, Wappingers Falls, NY (US); Maurice M. Materise, Dutchess, NY (US); Jessie Yu, Wappingers Falls, NY (US)

(21) Appl. No.: 15/627,748

(22) Filed: Jun. 20, 2017

(51) Int. Cl. G06Q 30/02; H04L 29/08

(52) U.S. Cl. CPC G06Q 30/0269; G06Q 30/0257; G06Q 30/0217; H04L 67/306; G06Q 30/0254

(57) ABSTRACT

Examples of techniques for displaying an advertisement for a product of interest are disclosed. In one example implementation according to aspects of the present disclosure, a computer-implemented method includes identifying, by a processing device, a product of interest. The method further includes retrieving, by the processing device, information about the product of interest. The method further includes retrieving, by the processing device, an advertisement associated with the product of interest based at least in part on the information about the product of interest. The method further includes displaying, by the processing device, the advertisement associated with the product of interest.

### BACKGROUND

The present invention generally relates to advertisements, and more specifically, to displaying an advertisement for a product of interest.

Advertisements (i.e., commercials) can be used to promote or sell a product or service. For example, an advertiser creates a commercial to promote its product(s) or service(s) and pays to have the commercial presented through various media such as television, radio, newspapers, periodicals, websites, etc. Consumers of the media are then exposed to the commercial.

### SUMMARY

Embodiments of the present invention are directed to a computer-implemented method for displaying an advertisement for a product of interest. A non-limiting example of the computer-implemented method includes identifying, by a processing device, a product of interest. The method further includes retrieving, by the processing device, information about the product of interest. The method further includes retrieving, by the processing device, an advertisement associated with the product of interest based at least in part on the information about the product of interest. The method further includes displaying, by the processing device, the advertisement associated with the product of interest.

Additional embodiments of the present invention are directed to a system for displaying an advertisement for a product of interest. Yet additional embodiments of the invention are directed to a computer program product for displaying an advertisement for a product of interest.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a cloud computing environment according to an embodiment of the present invention;

FIG. 2 depicts abstraction model layers according to an embodiment of the present invention;

FIG. 3 depicts a block diagram of a processing system for implementing the techniques described herein, according to embodiments of the present invention;

FIG. 4 depicts a block diagram of a processing system for displaying an advertisement for a product of interest, according to embodiments of the present invention;

FIG. 5 depicts a flow diagram of a method for displaying an advertisement for a product of interest, according to embodiments of the present invention; and

FIG. 6 depicts a flow diagram of a method for displaying an advertisement for a product of interest, according to embodiments of the present invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

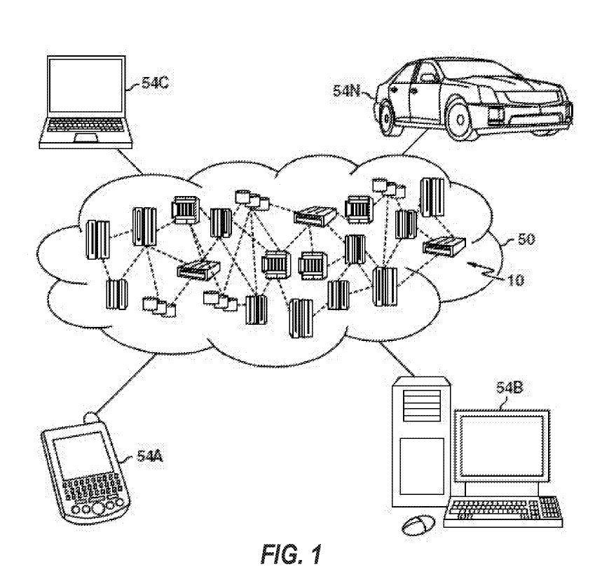

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

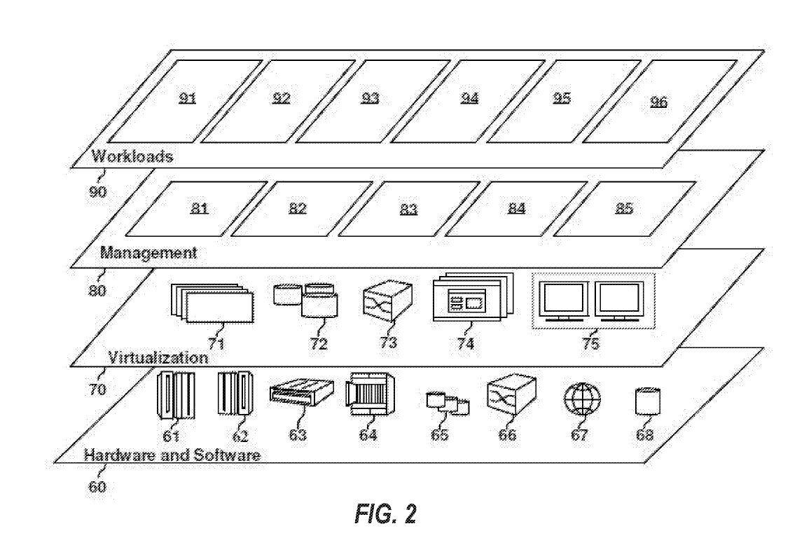

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and displaying an advertisement for a product of interest 96.

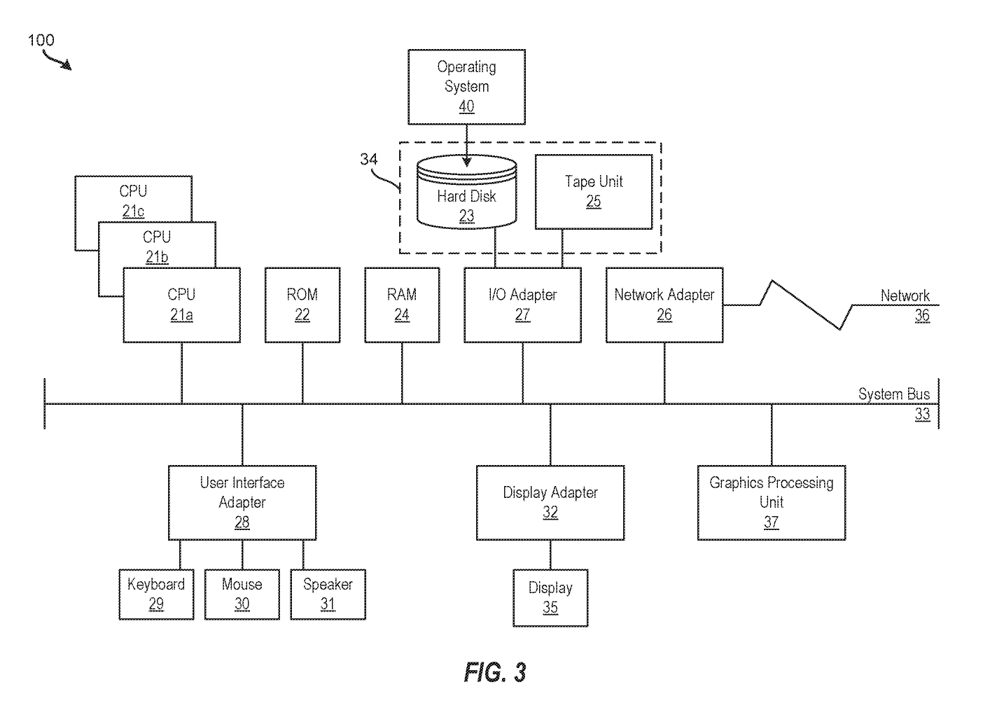

It is understood that embodiments of the present invention are capable of being implemented in conjunction with any other suitable type of computing environment now known or later developed. For example, FIG. 3 illustrates a block diagram of a processing system 100 for implementing the techniques described herein. In examples, processing system 100 has one or more central processing units (processors) 21a, 21b, 21c, etc. (collectively or generically referred to as processor(s) 21 and/or as processing device(s)). In aspects of the present disclosure, each processor 21 may include a reduced instruction set computer (RISC) microprocessor. Processors 21 are coupled to system memory (e.g., random access memory (RAM) 24) and various other components via a system bus 33. Read only memory (ROM) 22 is coupled to system bus 33 and may include a basic input/output system (BIOS), which controls certain basic functions of processing system 100.

Further illustrated are an input/output (I/O) adapter 27 and a communications adapter 26 coupled to system bus 33. I/O adapter 27 may be a small computer system interface (SCSI) adapter that communicates with a hard disk 23 and/or a tape storage drive 25 or any other similar component. I/O adapter 27, hard disk 23, and tape storage device 25 are collectively referred to herein as mass storage 34. Operating system 40 for execution on processing system 100 may be stored in mass storage 34. A network adapter 26 interconnects system bus 33 with an outside network 36 enabling processing system 100 to communicate with other such systems.

A display (e.g., a display monitor) 35 is connected to system bus 33 by display adaptor 32, which may include a graphics adapter to improve the performance of graphics intensive applications and a video controller. In one aspect of the present disclosure, adapters 26, 27, and/or 32 may be connected to one or more I/O busses that are connected to system bus 33 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 33 via user interface adapter 28 and display adapter 32. A keyboard 29, mouse 30, and speaker 31 may be interconnected to system bus 33 via user interface adapter 28, which may include, for example, a Super I/O chip integrating multiple device adapters into a single integrated circuit.

In some aspects of the present disclosure, processing system 100 includes a graphics processing unit 37. Graphics processing unit 37 is a specialized electronic circuit designed to manipulate and alter memory to accelerate the creation of images in a frame buffer intended for output to a display. In general, graphics processing unit 37 is very efficient at manipulating computer graphics and image processing and has a highly parallel structure that makes it more effective than general-purpose CPUs for algorithms where processing of large blocks of data is done in parallel.

Thus, as configured herein, processing system 100 includes processing capability in the form of processors 21, storage capability including system memory (e.g., RAM 24), and mass storage 34, input means such as keyboard 29 and mouse 30, and output capability including speaker 31 and display 35. In some aspects of the present disclosure, a portion of system memory (e.g., RAM 24) and mass storage 34 collectively store an operating system such as the AIX® operating system from IBM Corporation to coordinate the functions of the various components shown in the processing system 100.

Turning now to an overview of technologies that are more specifically relevant to aspects of the invention, advertisements (i.e., commercials) can be used to promote or sell a product or service. For example, an advertiser creates a commercial to promote its product(s) or service(s) and pays to have the commercial presented through various media such as television, radio, newspapers, periodicals, websites, etc. Consumers of the media are then exposed to the commercial.

Existing advertisements are generally presented to potential consumers without regard for the consumers' interests. For example, a television commercial is shown to all viewers of a particular program or show whether or not the viewers are interested in whatever the commercial is promoting. In many cases, the viewers may be presented with advertisements that are irrelevant to the user and/or are not interesting to the user.

Turning now to an overview of the aspects of the invention, one or more embodiments of the invention address the above-described shortcomings of the prior art by displaying an advertisement for a product of interest for a user. To do this, the user first captures information about a product of interest using a processing system such as a smartphone, tablet computer, wearable computer, laptop computer, or another suitable processing system. The captured information is used to retrieve an advertisement associated with the product of interest. The advertisement associated with the product of interest is then displayed to the user.

An advertisement associated with the product of interest can be displayed to the user instead of another advertisement that may not be of interest to the user. In some embodiments of the present invention, the advertisement is displayed at a later time than when the information about the product is captured. For example, if the user is out shopping and sees a particular item that is of interest to the user, the user can capture information about the product of interest. Later, when the user is consuming the media content (e.g., watching television, streaming video online, etc.), the advertisement associated with the product of interest can be displayed to the user in place of a generic advertisement that would otherwise be displayed, which might not be of interest to the user. This enables users to obtain information about a product of interest instead of being subjected to advertisements that are not relevant to the user.

The above-described aspects of the invention address the shortcomings of the prior art by enabling a user to view content of interest to the user rather than generic content that may not be of interest to the user. For example, if a user is at a car dealership and is interested in a particular car, the user can capture information about the car. The information about the car is used to retrieve an advertisement associated with the car, and the advertisement associated with the car is displayed to the user.

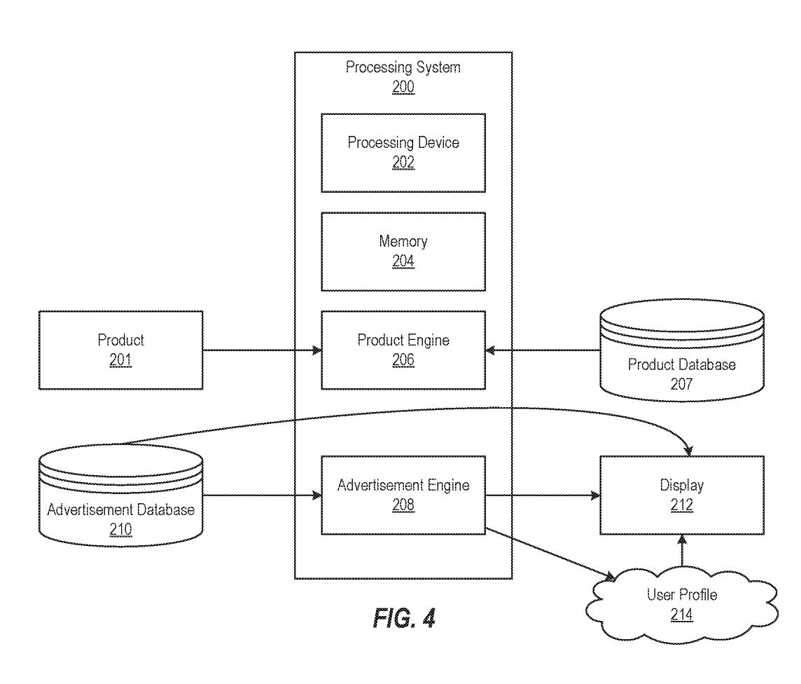

Turning now to a more detailed description of aspects of the present invention, FIG. 4 depicts a processing system 200 for displaying an advertisement for a product of interest, according to embodiments of the present invention. The processing system 200 includes a processing device 202, a memory 204, a product engine 206, and an advertisement engine 208. The various components, modules, engines, etc. described regarding FIG. 4 may be implemented as instructions stored on a computer-readable storage medium, as hardware modules, as special-purpose hardware (e.g., application specific hardware, application specific integrated circuits (ASICs), as embedded controllers, hardwired circuitry, etc.), or as some combination or combinations of these.

In examples, the engine(s) described herein may be a combination of hardware and programming. The programming may be processor executable instructions stored on a tangible memory, and the hardware may include the processing device 202 for executing those instructions. Thus a system memory (e.g., the memory 204) can store program instructions that when executed by the processing device 202 implement the engines described herein. Other engines may also be utilized to include other features and functionality described in other examples herein. Alternatively or additionally, the processing system 202 can include dedicated hardware, such as one or more integrated circuits, Application Specific Integrated Circuits (ASICs), Application Specific Special Processors (ASSPs), Field Programmable Gate Arrays (FPGAs), or any combination of the foregoing examples of dedicated hardware, for performing the techniques described herein.

A user of the processing system 200 uses the product engine 206 to identify a product of interest (e.g., the product 201) and retrieve information about the product 201. The product engine 206 can utilize a camera, scanner, near-field communication reader, radio frequency identifier (RFID) reader, or another suitable device to identify the product 201. For example, the product engine 206 can identify product 201 using a camera and object recognition. The product engine 206 can also identify the product 201 by scanning a barcode, QR code, radio-frequency identifier, etc.

The product engine 206 then can reference a product database 207 to retrieve information about the product 201. For example, the product engine 206 can use a captured image to identify the product 201 by comparing the captured image to other images in the product database. Similarly, the product engine 206 can compare a product code (e.g., a barcode, a RFID code, etc.) with product codes in the product database 207. The product database can also store additional information about the product 201, such as pricing information, a model number, a size, etc. that can later be displayed to the customer. For example, if the product engine 206 scans a barcode or other identifier associated with a product of interest, the product engine 206 can access the product database 207 to retrieve additional product information (e.g., manufacturer, model number, price, specifications, reviews, etc.) about the product 201.

Once the product 201 is identified and information about the product 201 is retrieved, the advertisement engine 208 retrieves an advertisement associated with the product 201. For example, the advertisement engine 208 uses the information retrieved from the product database 207 about the product 201 to retrieve the advertisement from the advertisement database 210.

The advertisement engine 208 can then cause the advertisement to be displayed directly or indirectly. For example, the advertisement can be displayed directly on the display 212 that may be integrated into the processing system 200, connected (e.g., via a wired or wireless connection) to the processing system 200, or otherwise associated with the processing system 200 such that the advertisement engine 208 causes the advertisement to be displayed on the display 212. The advertisement can also (or instead) be displayed indirectly on a display that is remote from the processing system 200. For example, a user may view the advertisement on a television remote from the processing system 200, such as by accessing the user's user profile 214 as discussed herein. According to embodiments of the present invention, the display 212 can receive the advertisement directly from the advertisement database 210, from the advertisement engine 208, or from another suitable source.

In some embodiments, the advertisement engine 208 can queue the advertisement so that the advertisement can be displayed at a later time. For example, if a user is out shopping and identifies the product 201 as a product of interest, the user can take a picture of the product 201, scan a barcode associated with the product 201, etc. The product engine 206 identifies the product 201, retrieves information about the product of interest from the product database 207 and queues an advertisement for later consumption by the user. If the user is watching a television program later, the advertisement associated with the product 201 can be displayed to the user instead of another advertisement. For example, if a television program has a generic advertisement (i.e., a commercial) for a generic product/service scheduled to be displayed to users watching the television program, the advertisement associated with the product 201 can be displayed to the user of the processing system 200 instead of the generic advertisement. This enables the user to receive information about a product that is of interest to the user instead of another advertisement that may not interest the user.

In addition, the advertisement engine 208 can display additional product information associated with the product to the user on the display 212. This additional product information can include, for example, manufacturer, model number, price, specifications, reviews, etc.

In some examples, the advertisement engine 208 can store credits for the user when the user views the advertisement. For example, once a user views an advertisement, the advertisement engine 208 can generate a credit that can be applied later. This may be useful when the user is viewing content that includes commercials/advertisements, and the user desires to skip the commercials/advertisements. By watching the advertisement for the product of interest in advance and earning a credit for doing so, the credit can be applied to a user profile 214 for the user. The user profile 214 is unique to the user and is accessible by a passcode, username/password, token, or other authentication technique. According to some examples, the credit can be exchanged for a discount on the product of interest or another product, for monetary value, or for some other value.

The user can access his user profile 214 from different devices, which enables the user to identify a product of interest on one device (e.g., the processing system 200) and to watch the advertisement associated with the product of interest on another device (e.g., a television). The user profile 214 may store a list of queued advertisements that are based on various products of interest to the user. The user profile 214 can enable the user to reorder the queue so to change the order that the advertisements are shown. The user profile 214 can also enable the user to view advertisements on demand. This enables the user to earn credits as described above.

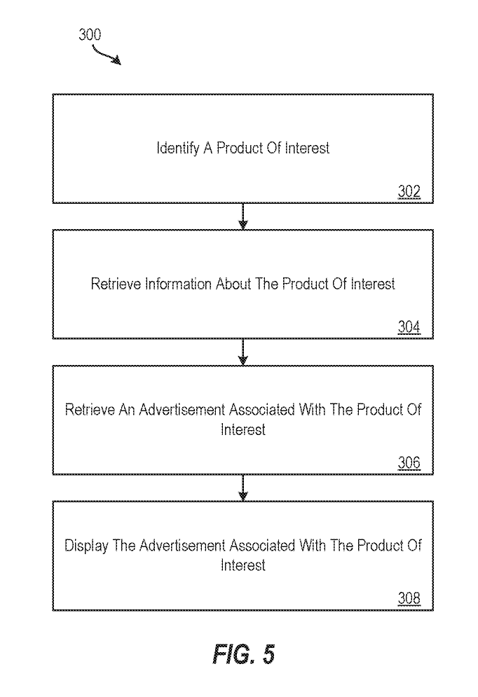

FIG. 5 depicts a flow diagram of a method 300 for displaying an advertisement for a product of interest, according to embodiments of the present invention. The method 300 can be implemented using any suitable processing system or device, such as the processing system 100 of FIG. 3, the processing system 200 of FIG. 4, or another suitable processing system or device.

At block 302, the product engine 206 identifies the product of interest. To identify the product of interest, the product engine 206 of the processing system 200 captures information about the product of interest. The product engine 206 can use a camera, scanner, near-field communication reader, RFID reader, etc., to identify the product of interest (e.g., the product 201).

At block 304, the product engine 206 retrieves information about the product of interest, such as from the product database 207. At block 306, the advertisement engine 208 of the processing system 200 retrieves an advertisement associated with the product of interested based on the information captured about the product. The advertisement can be retrieved from the advertisement database 210.

At block 308, the advertisement engine 208 of the processing system 200 displays the advertisement associated with the product of interest. The advertisement can be displayed on the display 212, which can include any suitable display. For example, the display can be a display integrated with and/or connected to the processing system 200. In an example in which the processing system 200 is a smartphone, the display 212 can be a touchscreen integrated into the smartphone. In another example, the display 212 can be separate from the processing system 200. For example, the display 212 can be a television separate from the processing system 200. In such cases, the television can display the advertisement associated with the product of interest, such as by receiving the advertisement from the processing system 200 or by retrieving the advertisement directly from the advertisement database 210.

Additional processes also may be included, and it should be understood that the processes depicted in FIG. 5 represent illustrations, and that other processes may be added or existing processes may be removed, modified, or rearranged without departing from the scope and spirit of the present disclosure.

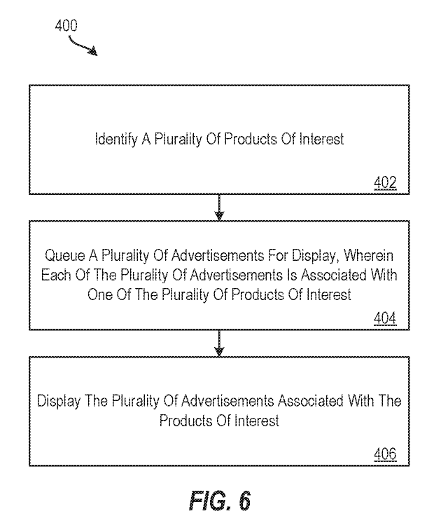

FIG. 6 depicts a flow diagram of a method 400 for displaying an advertisement for a product of interest, according to embodiments of the present invention. The method 400 can be implemented using any suitable processing system or device, such as the processing system 100 of FIG. 3, the processing system 200 of FIG. 4, or another suitable processing system or device.

At block 402, the product engine 206 of the processing system 200 identifies a plurality of products of interest. At block 404, the advertisement engine 206 of the processing system 200 queues a plurality of advertisements for display. Each of the plurality of advertisements is associated with one of the plurality of products of interest.

At block 406, the plurality of advertisements associated with the plurality of products of interest are displayed to a user on a display 212. The plurality of advertisements can be displayed in the order they are queued, in a random order, in a user selected order, or in another suitable order.

Additional processes also may be included, and it should be understood that the processes depicted in FIG. 6 represent illustrations, and that other processes may be added or existing processes may be removed, modified, or rearranged without departing from the scope and spirit of the present disclosure.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed:

1-11. (canceled)

12. A system for displaying an advertisement for a product of interest, the system comprising:
a memory comprising computer readable instructions; and
a processing device for executing the computer readable instructions for performing a method, the method comprising:
identifying, by a processing device, a product of interest;
retrieving, by the processing device, information about the product of interest;
retrieving, by the processing device, an advertisement associated with the product of interest based at least in part on the information about the product of interest; and
displaying, by the processing device, the advertisement associated with the product of interest.

13. The system of claim 12, wherein displaying the advertisement for the product of interest occurs at a later time than the identifying.

14. The system of claim 12, wherein the advertisement for the product of interest is displayed on a display.

15. The system of claim 14, wherein the display is connected to the processing device.

16. The system of claim 12, wherein the display is remote from the processing device.

17. A computer program product for displaying an advertisement for a product of interest, the computer program product comprising:
a computer readable storage medium having program instructions embodied therewith, wherein the computer readable storage medium is not a transitory signal per se, the program instructions executable by a processing device to cause the processing device to perform a method comprising:
identifying, by a processing device, a product of interest;
retrieving, by the processing device, information about the product of interest;
retrieving, by the processing device, an advertisement associated with the product of interest based at least in part on the information about the product of interest; and
displaying, by the processing device, the advertisement associated with the product of interest.

18. The computer program product of claim 12, wherein displaying the advertisement for the product of interest occurs at a later time than the identifying.

19. The computer program product of claim 12, wherein the advertisement for the product of interest is displayed on a display.

20. The computer program product of claim 19, wherein the display is connected to the processing device.
